(19) United States
(12) Patent Application Publication
(10) Pub. No.: US 2009/0049128 A1
(43) Pub. Date: Feb. 19, 2009

(54) Schemes for game chat routing and taunt control

(75) Inventor: Gary Zalewski, Oakland, CA (US)

Correspondence Address: GLENN PATENT GROUP, 3475 EDISON WAY, SUITE L, MENLO PARK, CA, 94025, US

(73) Assignee: Sony Computer Entertainment America Inc.

(21) Appl. No.: 11/893,844

(22) Filed: Aug. 17, 2007

(51) Int. Cl. G06F 15/16

(52) U.S. Cl. 709/204

(57) ABSTRACT

In one embodiment, the methods and apparatuses detect an application; detect a participant within the application; detect a distance between multiple participants; monitor the application for a qualifying event; and selectively initiate a communication channel between multiple participants based on the qualifying event and the distance between the multiple participants.

### FIELD OF THE INVENTION

The present invention relates generally to communicating based on a location and, more particularly, to selectively communicating based on a location and event.

### BACKGROUND

Interactive applications such as video games and computer games allow multiple participants to interact with each other. During these interactive applications, participants typically perform acts that are graphically shown on a display device and are audibly heard through a sound device for all other participants to see and hear, respectively.

In some instances, the interactive applications offer communication channels between a pre-selected group of participants. For example, participants on the same team may be able to communicate with other participants on the same team through audio and/or visual embodiments. Participants of opposite teams are typically not allowed to communicate with each other. In some instances, these limitations on communication between participants on opposite teams prevent participants on opposite teams to spontaneously communicate with each other. Further, there are circumstances and events during the interactive applications that would be beneficial to allow participants that do not have a pre-existing communications channel to spontaneously communicate with each other.

### SUMMARY

In one embodiment, the methods and apparatuses detect an application; detect a participant within the application; detect a distance between multiple participants; monitor the application for a qualifying event; and selectively initiate a communication channel between multiple participants based on the qualifying event and the distance between the multiple participants.

### BRIEF DESCRIPTION OF THE DRAWINGS

The accompanying drawings, which are incorporated in and constitute a part of this specification, illustrate and explain one embodiment of the schemes for game chat routing and taunt control. In the drawings,

FIG. 1 is a diagram illustrating an environment within which the schemes for game chat routing and taunt control are implemented;

FIG. 2 is a simplified block diagram illustrating one embodiment in which the schemes for game chat routing and taunt control are implemented;

FIG. 3 is a simplified block diagram illustrating a system, consistent with one embodiment of the schemes for game chat routing and taunt control;

FIG. 4 illustrates an exemplary record consistent with one embodiment of the schemes for game chat routing and taunt control; and

FIG. 5 is a flow diagram consistent with one embodiment of the schemes for game chat routing and taunt control.

### DETAILED DESCRIPTION

The following detailed description of the schemes for game chat routing and taunt control refers to the accompanying drawings. The detailed description is not intended to limit the schemes for game chat routing and taunt control.

Instead, the scope of the schemes for game chat routing and taunt control is defined by the appended claims and equivalents. Those skilled in the art will recognize that many other implementations are possible, consistent with the schemes for game chat routing and taunt control.

References to “electronic device” include a device such as a personal digital video recorder, digital audio player, gaming console, a set top box, a radio, a television, a personal computer, a cellular telephone, a personal digital assistant, and the like.

References to “participant” include a representation of a player within a video game, a computer game, and the like. In one embodiment, the participant is a player that is controlled by an operator of an electronic device. In another embodiment, the participant is a player that is controlled by an electronic device.

References to “content” include audio streams, images, video streams, photographs, graphical displays, text files, software applications, electronic messages, video games including associated player data, and the like.

References to “application” include a video game, an on-line game through the internet, a computer game, and the like.

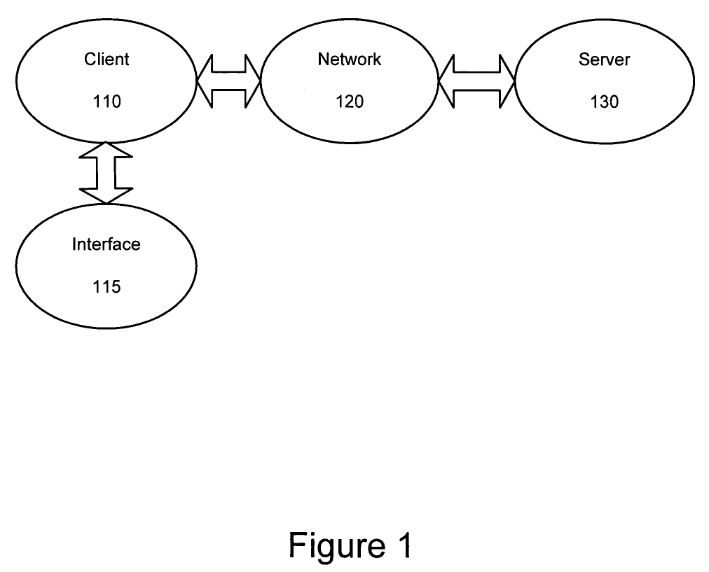

FIG. 1 is a diagram illustrating an environment within which the schemes for game chat routing and taunt control are implemented. The environment includes an electronic device 110 (e.g., a computing platform configured to act as a client device, such as a personal digital video recorder, digital audio player, computer, a personal digital assistant, a cellular telephone, a camera device, a set top box, a gaming console), a user interface 115, a network 120 (e.g., a local area network, a home network, the Internet), and a server 130 (e.g., a computing platform configured to act as a server). In one embodiment, the network 120 can be implemented via wireless or wired solutions.

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device such as a mouse and trackball, a microphone, a speaker, a display, a camera) are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments illustrating schemes for game chat routing and taunt control as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

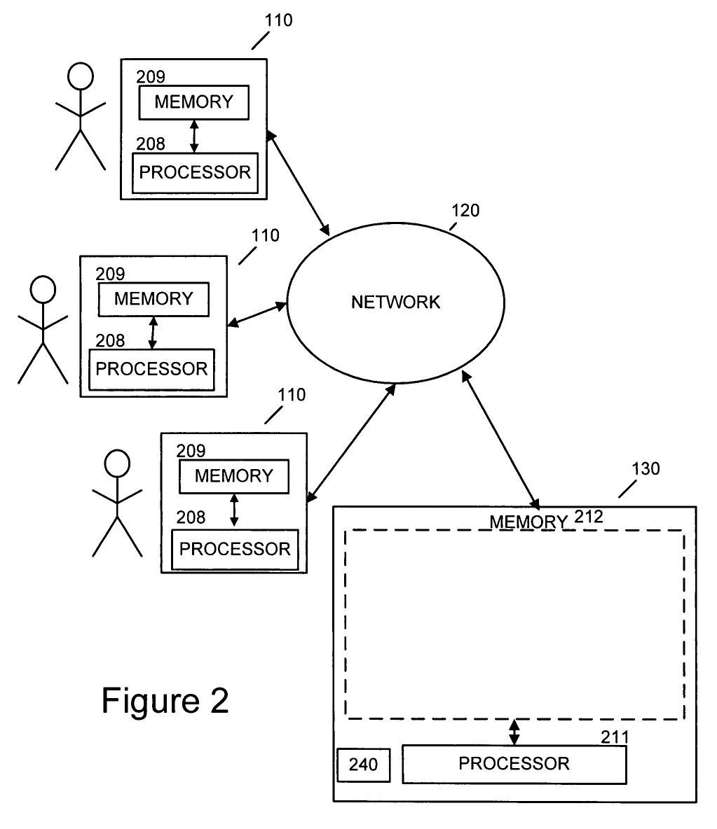

FIG. 2 is a simplified diagram illustrating an exemplary architecture in which the schemes for game chat routing and taunt control are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application illustrating schemes for game chat routing and taunt control. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on selectively communicating based on a location and event as determined using embodiments described below.

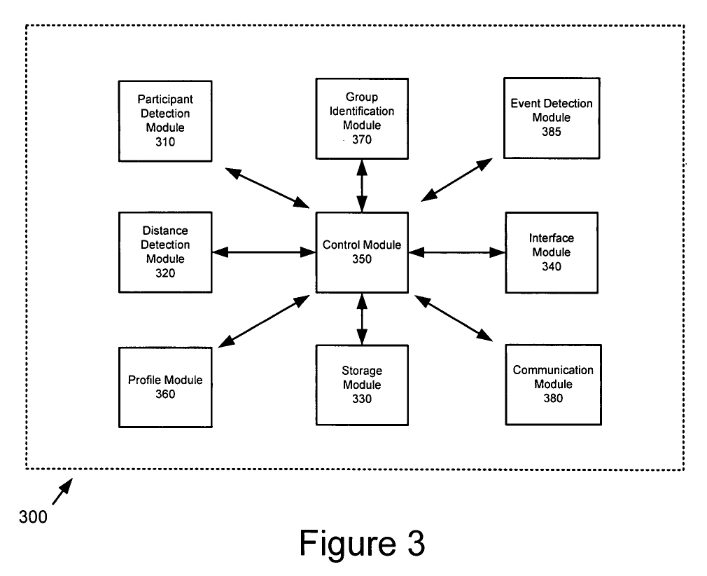

FIG. 3 illustrates one embodiment of a system 300 showing schemes for game chat routing and taunt control. The system 300 includes a participant detection module 310, a distance detection module 320, a storage module 330, an interface module 340, a control module 350, a profile module 360, a group identification module 370, a communication module 380, and an event detection module 385.

In one embodiment, the control module 350 communicates with the participant detection module 310, the distance detection module 320, the storage module 330, the interface module 340, the profile module 360, the group identification module 370, the communication module 380, and the event detection module 385.

In one embodiment, the control module 350 coordinates tasks, requests, and communications between the participant detection module 310, the distance detection module 320, the storage module 330, the interface module 340, the profile module 360, the group identification module 370, the communication module 380, and the event detection module 385.

In one embodiment, the participant detection module 310 detects participants. In one embodiment, the participants are represented by players within a video game. For example, the players within the video game may be controlled by the gaming console or may be controlled by an operator of the gaming console. In one embodiment, the participant detection module 310 simultaneously detects multiple participants. In one instance, each of the participants may be controlled by a different gaming console such that multiple gaming consoles are utilized simultaneously to control the multiple participants.

In one embodiment, the distance detection module 320 detects the distance between each of the participants that are detected by the participant detection module 310. In one embodiment, the distance is simply measured between each of the participants. In another embodiment, the distance is measured between each of the participants relative to a references point. In one embodiment, the distance between the participants is measured within a 2-dimensional surface. In another embodiment, the distance between the participants is measured within a 3-dimensional space.

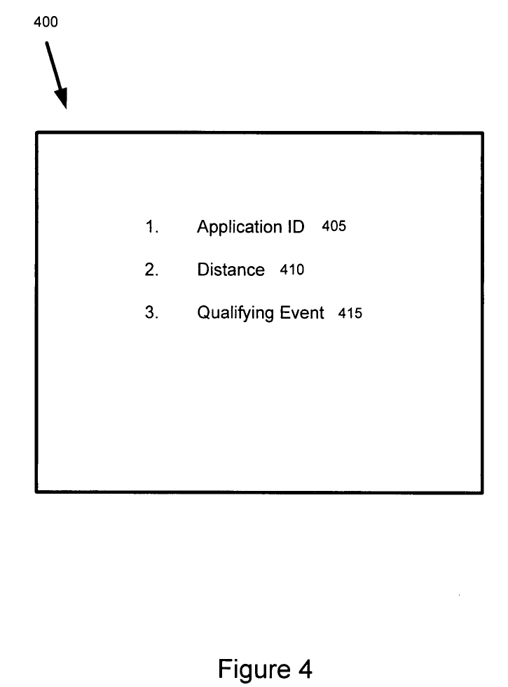

In one embodiment, the storage module 330 stores a plurality of profiles wherein each profile is associated with a particular application and associated parameters related to the participants. In one embodiment, the profile stores exemplary information as shown in a profile illustrated in FIG. 4. In one embodiment, the storage module 330 is located within the server device 130. In another embodiment, portions of the storage module 330 are located within the electronic device 110.

In one embodiment, the interface module 340 detects the electronic device 110 as the electronic device 110 is connected to the network 120.

In another embodiment, the interface module 340 detects input from the interface device 115 such as a keyboard, a mouse, a microphone, a still camera, a video camera, and the like.

In yet another embodiment, the interface module 340 provides output to the interface device 15 such as a display, speakers, external storage devices, an external network, and the like.

In one embodiment, the profile module 360 processes profile information related to the specific content and each specific viewer. In one embodiment, exemplary profile information is shown within a record illustrated in FIG. 4. In one embodiment, each profile corresponds with a particular application. For example, the application is a video game in one embodiment.

In one embodiment, the group identification module 370 determines which participants form a group. In one embodiment, determination of the particular participants that make up the group is based on parameters that are disclosed within a profile. In one embodiment, exemplary parameters include the distance between each of the participants and whether the participants are on the same team.

In one embodiment, the communication module 380 selectively allows the participants within the group to communicate with each other based on a qualifying event. For example, when a qualifying event is detected, then the participants within the group are allowed to communicate with each other.

In one embodiment, the communications between the participants within the group are audio communications such as a telephone call. In another embodiment, the communications between the participants within the group are video communications such as a webcam session. In another embodiment, the communications between the participants within the group are textual communications such as instant messaging.

In one embodiment, the duration of the communication between the participants within the group can range from a few seconds to multiple minutes.

In one embodiment, the qualifying event is described within the record 400 as a profile. In one embodiment, the qualifying event includes an action by one of the participants such as discharging a pretend weapon, scoring a goal, basket, or touchdown, incapacitating another participant, making contact with another participant within the video game, and the like.

In one embodiment, the qualifying event occurs to one of the participants within the group that is able to communicate through the communication module 380. For example, the qualifying event occurs to a particular participant. The group that is formed that includes the particular participant based on the group identification module 370. In this example, the participants within the formed group are capable of communicating with each other through the communication module 380.

In another embodiment, the qualifying event occurs to any of the participants and allows the participants within each group to communicate through the communication module 380. For example, the qualifying event occurs to a particular participant. The group that is formed may or may not include the particular participant based on the group identification module 370. In this example, the participants within the formed group are capable of communicating with each other through the communication module 380.

In one embodiment, the event detection module 385 monitors the application and detects events that occur during the course of utilizing the application. In one embodiment, the event detection module 385 detect a qualifying event as it occurs while utilizing the application.

The system 300 in FIG. 3 is shown for exemplary purposes and is merely one embodiment of the schemes for game chat routing and taunt control. Additional modules may be added to the system 300 without departing from the scope of the schemes for game chat routing and taunt control. Similarly, modules may be combined or deleted without departing from the scope of the schemes for game chat routing and taunt control.

FIG. 4 illustrates a simplified record 400 that corresponds to a profile that describes communication between participants for a specific application. In one embodiment, the specific application is a video game. In one embodiment, the record 400 is stored within the storage module 330 and utilized within the system 300. In one embodiment, the record 400 includes an application identification field 405, a distance field 410, and a qualifying event field 415.

In one embodiment, the application identification field 405 identifies a specific application associated with the record 400. In one example, the application's name is utilized as a label for the content identification field 405.

In one embodiment, the distance field 410 includes a distance that provides parameters to include participants within a group that are within this distance. For example, if the distance is 20 feet, then participants that are within a 20 feet radius from a specified participant will be included within this group. In other examples, different distances may be utilized.

In one embodiment, the specified participant is a participant that is part of the qualifying event. In another embodiment, the specified participant is every participant that is included within the application. In yet another embodiment, the specified participant is a participant that is not part of the qualifying event.

In one embodiment, the qualifying event field 415 identifies various events that would trigger a communication between participants within a group. In one embodiment, an exemplary qualifying event includes success in hitting a target, scoring a goal, scoring a touchdown, capturing a target, eliminating a target, and the like.

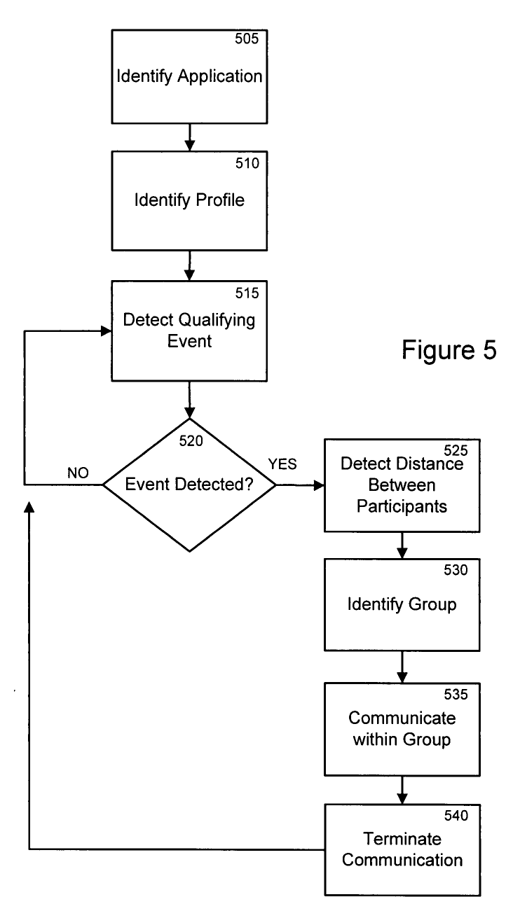

The flow diagram as depicted in FIG. 5 is one embodiment of the schemes for game chat routing and taunt control. The blocks within the flow diagram can be performed in a different sequence without departing from the spirit of the schemes for game chat routing and taunt control. Further, blocks can be deleted, added, or combined without departing from the spirit of the schemes for game chat routing and taunt control.

The flow diagram in FIG. 5 illustrates selectively allowing a group of participants to communicate with each other according to one embodiment of the invention.

In Block 505, the application is identified. In one embodiment, specific application such as a specific video game is detected and identified. In one embodiment, the specific video game may be selected from a plurality of content. Further, the plurality of applications may include multiple types of content such as video games, computer games, and interactive content, and the like. In one embodiment, the plurality of content is stored within the storage module 330.

In Block 510, a profile corresponding with the identified application within the Block 505 is identified. An exemplary profile is illustrated as record 400 within FIG. 4. In the event that a corresponding profile that is unique to the identification application is not found or identified, a general profile may be identified as a substitute in one embodiment.

In Block 515, a qualifying event is detected. In one embodiment, a qualifying event is listed within a profile identified within the Block 510. In one embodiment, the events occurring within the application are monitored. In one embodiment, the events that are monitored are initiated by one of the participants. In another embodiment, the events that are monitored are initiated by the application.

In Block 520, a determination is made on whether a qualifying event is detected.

If there is no qualifying event detected, then additional detection is performed within the Block 515.

If there is a qualifying event detected, then the distance between participants is detected within Block 525.

In Block 530, a group of participants is identified. In one embodiment, a participant is identified based on the qualifying event. For example, if scoring a goal in a game is a qualifying event and the goal is scored by a participant, then this participant that scored the goal is identified. In a similar example, a participant that assists in scoring the goal may also be identified.

In another embodiment, every participant within the vicinity of the qualifying event is also identified. For example, if scoring a goal in a game is a qualifying event, then all participants within the area of the goal being scored are identified.

In yet another embodiment, every participant within the application during a qualifying event is also identified. For example, if scoring a goal in a game is a qualifying event, then all participants within the application when the goal is scored are identified.

Based on the identified participant, other participants that are within a predetermined distance of the identified participant are considered to be within a group with the identified participant. In one embodiment, the predetermined distance is found within the profile identified within the Block 510. In another embodiment, the predetermined distance may be a default distance.

In Block 535, the participants within the group identified within the Block 530 are able to communicate with each other. In one embodiment, the communication occurs through an audio communication such as voice call. In another embodiment, the communication occurs through a textual communication such as instant messaging. In yet another embodiment, the communication occurs through a video communication such as a webcam session. In one embodiment, multiple groups of participants may communicate within their group simultaneously.

In Block 540, the communication within the group terminates after a period of time after the qualifying event is detected and recognized within the Blocks 515 and 520. In one embodiment, the communication provided within the Block 535 terminates X minutes after the qualifying event. “X” can be any number or fraction of minutes.

In one example, the application may be a soccer game utilizing a video game console. In this example, there are two teams. As two competing participants on different teams are near each other, one of these participants scores a goal against the other participant's team. In one embodiment, both these participants would not ordinarily communicate with each other. However, in one embodiment, scoring the goal is a qualifying event and both participants are within the predetermined distance from each other. In one embodiment, the participant scoring the goal is the identified participant. Accordingly, both participants are capable of communicating with each other for a period of time in one embodiment. Further, the communications between both these participants may pertain to the qualifying event which in this case is scoring the goal. In one embodiment, each participant is represented by an individual operator of the video game console.

The preceding example illustrates one embodiment. Another embodiment includes an action/adventure game having multiple teams where the qualifying event may be striking a participant on the opposite team. Further, in other embodiments, different variations of games may be included with variations in the qualifying events.

The foregoing descriptions of specific embodiments of the invention have been presented for purposes of illustration and description. For example, the invention is described within the context of schemes for game chat routing and taunt control as merely one embodiment of the invention. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method comprising:
detecting an application;
detecting a participant within the application;
detecting a distance between multiple participants;
monitoring the application for a qualifying event; and
selectively initiating a communication channel between multiple participants based on the qualifying event and the distance between the multiple participants.

2. The method according to claim 1 wherein the application is one of a video game, a computer game, and an interactive game.

3. The method according to claim 1 wherein the participant is configured to be controlled by the application.

4. The method according to claim 1 wherein the participant is configured to be controlled by an individual.

5. The method according to claim 1 wherein the participant represents a character within the application.

6. The method according to claim 1 further comprising matching a profile with the application.

7. The method according to claim 6 wherein the profile further includes a threshold distance such that when the participant is within the threshold distance, the communication channel is initiated.

8. The method according to claim 6 wherein the profile further includes a time duration such that when the communication channel is initiated, the communication channel remains open for the time duration.

9. The method according to claim 6 wherein the profile further includes a predetermined qualifying event such that when the qualifying event matches the predetermined qualifying event, the communication channel is initiated.

10. The method according to claim 1 wherein the qualifying event is one of scoring a goal, hitting a target, falling down, and firing a fictional weapon.

11. The method according to claim 1 further communicating between the multiple participants through the communication channel.

12. The method according to claim 11 wherein the communication channel is configured to allow audio communications.

13. The method according to claim 11 wherein the communication channel is configured to allow graphical communications.

14. The method according to claim 11 wherein the communication channel is configured to allow textual communications.

15. The method according to claim 1 further comprising identifying a group of multiple participants based on the distance between the multiple participants and a threshold distance.

16. A system, comprising:
a participant detection module configured for detecting a plurality of participants within an application;
a group identification module configured for identifying a group of participants from the plurality of participants based on a distance between the plurality of participants;
an event detection module configured to detect a qualifying event during use of the application;
a communication module configured to allow a communication channel between the group of participants based on the qualifying event.

17. The system according to claim 16 wherein the qualifying event is one of scoring a goal, hitting a target, falling down, and firing a fictional weapon.

18. The system according to claim 16 wherein the application is one of a video game, a computer game, and an interactive game.

19. The system according to claim 16 further comprising a distance detection module configured to detect a distance between the plurality of participants.

20. The method according to claim 16 wherein the communication channel is configured to allow audio communications.

21. The method according to claim 16 wherein the communication channel is configured to allow graphical communications.

22. The method according to claim 16 wherein the communication channel is configured to allow textual communications.

23. The system according to claim 16 further comprising a storage module configured for a profile.

24. The system according to claim 16 further comprising a profile module configured for storing a profile associated with the application.

25. The method according to claim 24 wherein the profile includes a predetermined qualifying event, a time duration, and a predetermined distance.

26. A computer-readable medium having computer executable instructions for performing a method comprising:
detecting an application;
detecting a participant within the application;
detecting a distance between multiple participants;
monitoring the application for a qualifying event; and
selectively initiating a communication channel between multiple participants based on the qualifying event and the distance between the multiple participants.
